(19) United States
(12) Patent Application Publication
(10) Pub. No.: US 2010/0062809 A1
(43) Pub. Date: Mar. 11, 2010

(54) Dialing System and Method Thereof

(76) Inventor: Tai Wai LUK, Hong Kong (HK)

Correspondence Address: Tai Wai LUK;c/o IFF, 333 W. Garvey Avenue, #B, PMB 601, Monterey Park, CA, 91754, US

(21) Appl. No.: 12/204,808

(22) Filed: Sep. 5, 2008

(51) Int. Cl. H04M 1/00

(52) U.S. Cl. 455/564

(57) ABSTRACT

A dialing system includes a user interactive unit, a response receiver and a central processing unit. The central processing unit is pre-programmed to first activate the user interactive unit to communicate an entry identification to the user for allowing the user to determine whether or not the entry identification communicated by the user interactive unit matches with the entry identification of the target phone number, wherein when the entry identification communicated by the unit interactive unit does not match with the entry identification of the target phone number, the user interactive unit is arranged to communicate the next identification entry to the user without dialing the corresponding phone number, and when the entry identification communicated by the user interactive unit matches with the entry identification of the target phone number, the central processing unit is arranged to activate the phone to dial the target phone number.

### BACKGROUND OF THE PRESENT INVENTION

1. Field of Invention

The present invention relates to a phone system, and more particularly to a dialing system and method thereof which are capable of communicating phone entries to a user through audible signal and activating dialing of a target phone number upon receipt of the user's confirmation in the form of a very convenient physical actuation.

2. Description of Related Arts

Conventionally, when a user wishes to dial a phone number by his or her cellular phone, he or she needs to either directly input an exact phone number to the cellular phone, or search from an electronic phone book for a particular contact person or contact number. Such process requires the user to look at the display screen of his or her cellular phone and manually operate the cellular phone to select the appropriate contact person or the exact phone number. While there is nothing wrong with this operation, dialing of a phone number using a cellular phone may impart to the user great danger or inconvenience when he or she is doing something else, such as driving.

When one is driving on the road and needs to dial a phone number by his or her cellular phone, the driver has three basic options. First, the driver can stop his or her car and complete the dialing procedure and conversation and resume driving afterwards. Second, the driver may need to operate the cellular phone while driving. Third, the user may utilize some sorts of wireless dialing control systems built-in in the vehicle. The first option imparts great inconvenience to the driver in that it may not be feasible for the driver to stop his or her vehicle and complete the dialing. The second option involves complicated legal issues because most states prohibit the use of a cellular phone while driving. Even if the driver is allowed to operate a cellular phone while driving, the dialing procedure may distract his concentration and cause potential serious traffic accident on the part of the driver.

The third option is regarded by most people as relatively acceptable and safe. But this is not necessarily true. While the driver, with the aid of the wireless dialing control system, may answer a phone call or conduct a conversation while driving, when he or she needs to dial a particular phone number stored in an electronic phone book, such wireless dialing control system does not help much. The driver still needs to direct his or her attention to the display screen of the cellular phone and manually operate the cellular phone to search for that particular phone number from the electronic phone book and activate dialing of that phone number. As a result, the driver has to be substantially distracted from normally driving the vehicle and may need to stop driving for safely completing the dialing procedure and finishing the conversation. In other words, the main problem for traditional cellular phones and wireless dialing control systems is that the user has to manually search a particular phone number for activating the corresponding dialing in the course of doing something else.

### SUMMARY OF THE PRESENT INVENTION

A main object of the present invention is to provide a dialing system and a method thereof which are capable of communicating phone entries to a user through audible signal and automatically activating dialing of a target phone number upon receipt of the user's confirmation in the form of a very convenient physical actuation.

Another object of the present invention is to provide a dialing system and a method thereof which are capable of delivering audio signal to a user as to the contents of an electronic phone book so as to allow the user to conveniently select a target phone number from the electronic phone book for activating the dialing procedure without being substantially distracted for operating the phone in question.

Another object of the present invention is to provide a dialing system and a method thereof which are capable of connecting with a phone, such as a cellular phone, for retrieving the electronic phone book and for activate dialing of a target phone number. The connection between the dialing system and the phone can be wired or wireless through prevalent communication technology.

Another object of the present invention is to provide a dialing system and a method thereof which are capable of incorporating with an existing remote control device, such as a remote control device for a multimedia unit in a vehicle, so as to facilitate widespread application of the present invention.

Another object of the present invention is to provide a dialing system and a method thereof which allow the user to dial a target phone number with minimal distraction to user's mental state of mind. As such, the present invention ensures the maximum safety of dialing a phone number via a cellular phone when the user is engaging in other activities, such as driving.

Another object of the present invention is to provide a dialing system and a method thereof, wherein the electronic phone book can be obtained from a wide variety of sources. As examples, the electronic phone book can be exported from the cellular phone, or retrieved directly from the phone book stored in the cellular phone. Moreover, the electronic phone book can also be created through other predetermined electronic devices, such as a computer.

Accordingly, in order to accomplish the above objects, the present invention provides a dialing system for activating a phone to dial a target phone number from an electronic phone book having a plurality of phone entries, wherein each of the phone entries includes an entry identification and a corresponding phone number, wherein the remote dialing system comprises:

a user interactive unit adapted for delivering an interactive signal to a user;

a response receiver for receiving a response signal from the user; and

a central processing unit electrically connecting with the response receiver and the user interactive unit and electrically connected with the phone to retrieve the phone entries, wherein the central processing unit is pre-programmed to activate the phone to dial the target phone number in such a manner that when the user wishes to dial the target phone number, the central processing unit is arranged to first activate the user interactive unit to communicate each of the entry identifications of each of the phone entries for allowing the user to determine whether or not the entry identification communicated by the user interactive unit matches with the entry identification of the target phone number, wherein when the entry identification communicated by the unit interactive unit does not match with the entry identification of the target phone number, the response receiver is arranged to receive a corresponding rejection response signal from the user to activate the user interactive unit to communicate the next identification entry without dialing the corresponding phone number, and when the entry identification communicated by the user interactive unit matches with the entry identification of the target phone number, the response receiver is arranged to receive the corresponding activation response signal from the user for confirming dialing of the target phone number, so that when the activation response signal is received and transmitted to the central processing unit, the central processing unit is arranged to activate the phone to dial the target phone number.

The present invention also provides a method of dialing a target phone number is through a dialing system comprising a user interactive unit, a response receiver and a central processing unit, wherein the method comprises the steps of:

(a) reading an electronic phone book by the central processing unit, wherein the electronic phone book stores a plurality of phone entries, wherein each of the phone entries includes an entry identification and a corresponding phone number, wherein the target phone number and the corresponding entry identification is pre-stored in the phone book as one of the phone entries;

(b) when the user wishes to dial the target phone number, communicating each of the entry identifications of each of the phone entries to the user for allowing the user to determine whether or not the entry identification communicated by the user interactive unit matches with the entry identification of the target phone number;

(c) receiving a rejection response signal from the user by the response receiver when the entry identification communicated by the unit interactive unit does not match with the entry identification of the target phone number;

(d) continuously communicating the next identification entry to the user by the unit interactive unit without dialing the phone;

(e) receiving an activation response signal by the response receiver when the entry identification communicated by the user interactive unit matches with the entry identification of the target phone number; and

(f) activating the phone by the central processing unit to dial the target phone number.

These and other objectives, features, and advantages of the present invention will become apparent from the following detailed description, the accompanying drawings, and the appended claims.

### BRIEF DESCRIPTION OF THE DRAWINGS

FIG. 1 is a schematic diagram of a dialing system according to a preferred embodiment of the present invention.

FIG. 2 is a detailed schematic diagram of the dialing system according to the preferred embodiment of the present invention.

FIG. 3 is a method of dialing a target phone number through a dialing system according to the preferred embodiment of the present invention.

### DETAILED DESCRIPTION OF THE PREFERRED EMBODIMENT

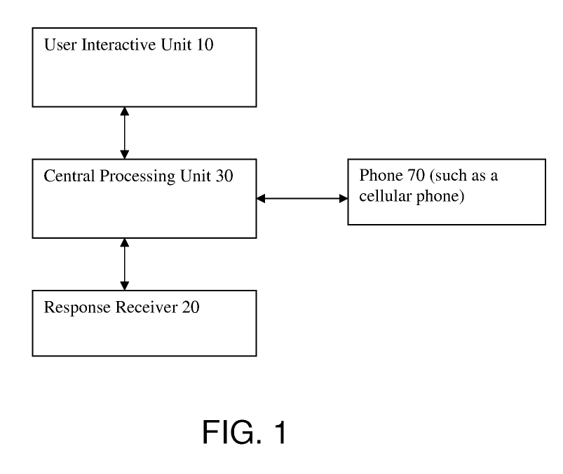

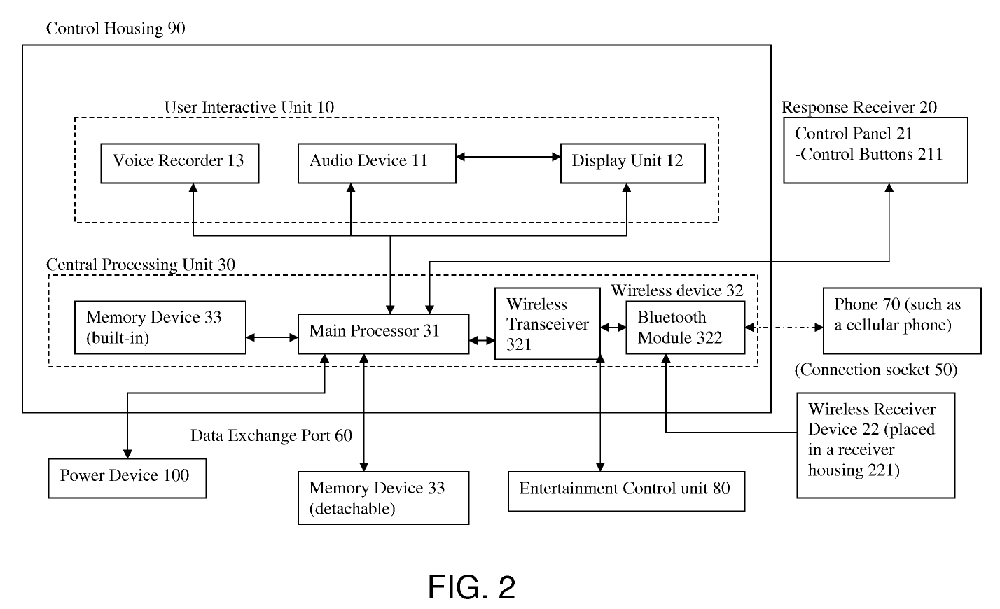

Referring to FIG. 1 to FIG. 2 of the drawings, a dialing system according to a preferred embodiment of the present invention is illustrated, in which the dialing system comprises a user interactive unit 10, a response receiver 20, and a central processing unit 30. The dialing system is for activating a phone 70, such as a cellular phone, to dial a target phone number from an electronic phone book having a plurality of phone entries 71, wherein each of the phone entries 71 includes an entry identification 711 and a corresponding phone number 712. An exemplary application of the present invention is in a vehicle. The electronic phone book can be obtained from a wide variety of sources. For example, the electronic phone book can be exported from the phone 70, or it can be retrieved directly from the phone book pre-stored in the phone 70. Moreover, the electronic phone book can also be created through other predetermined electronic devices, such as a computer, or pre-loaded into the central processing unit 30.

The user interactive unit 10 is adapted for delivering an interactive signal to a user. Such interactive signal is preferably in the form of an audible signal, such as a voice reading the entry identification 711 and/or the corresponding phone number 712 in a predetermined language. Alternatively, the interactive signal may be embodied as a text signal displayed on a specific display unit 12. The response receiver 20 is for receiving a response signal from the user.

The central processing unit 30 is electrically connected with the response receiver 20 and the user interactive unit 10 and electrically connected with the phone 70 to retrieve the phone entries 71, wherein the central processing unit 30 is pre-programmed to activate the phone 70 to dial the target phone number in such a manner that when the user wishes to dial the target phone number, the central processing unit 30 is arranged to first activate the user interactive unit 10 to communicate a corresponding entry identification 711 of a corresponding phone entry 71 to the user for allowing the user to determine whether or not the entry identification 711 communicated by the user interactive unit 10 matches with the entry identification 711 of the target phone number, wherein when the entry identification 711 communicated by the user interactive unit 10 does not match with the entry identification 711 of the target phone number, the response receiver 20 is arranged to receive the corresponding rejection response signal from the user to activate the user interactive unit 10 to communicate the next entry identification 711 without dialing the corresponding phone number 712, and when the entry identification 711 communicated by the user interactive unit 10 matches with the entry identification 711 of the target phone number, the response receiver 20 is arranged to receive the activation response signal from the user for confirming dialing of the target phone number, so that when the response signal is received and transmitted to the central processing unit 30, the central processing unit 30 is arranged to activate the phone 70 to dial the target phone number. Thus, the response signal of the user can be either a rejection response signal signaling that the entry identification 711 read by the user interactive unit 10 is not the entry identification 711 of the target phone number, or an activation response signal signaling that the entry identification 711 read by the user interactive unit 10 is the entry identification 711 of the target phone number.

According to the preferred embodiment of the present invention, the user interactive unit 10 comprises an audio device 11 preferably mounted in the user's vehicle or any other fixture, and arranged to deliver an audio signal, such as an audible voice signal, to the user for verbally communicating the entry identification 711 to the user. In other words, the user is able to hear an audible voice of the entry identification 711. For example, when a particular entry identification 711 is “David Young” the interactive signal of the user interactive unit 10 would be an audible sound “David Young” pronounced in a predetermined language, such as English. The audio device 11 comprises a speaker unit electrically connected with the central processing unit 30 to deliver the audible sound as to the entry identification 711 of each of the phone entries 71. The speaker unit may be embodied as a conventional speaker or a headset for allowing the user to hear the audible signal of the entry identification 711. In order to allow extensive application of the present invention, the audio device 11 is also adapted to deliver a digital or analog audio signal to another speaker system (such as the speaker system in a vehicle) to allow the speaker system to deliver the audible voice of the entry identification 711.

As an alternative of the user interactive unit 10, it can further comprise the display unit 12, such as a LCD screen, for displaying the text of the entry identification 711. For example, “David Young” can be shown on the LCD screen for informing the user of the entry identification 711 which the user interactive unit 10 is arranged to confirm with the user, and which the central processing unit 30 is arranged to dial upon receipt of a corresponding confirmation by the user.

The response receiver 20 comprises a control panel 21 mounted in the user's vehicle or any fixture in the vicinity of the user interactive unit 10 and is arranged to receive a user's actuation in responsive to the interactive signal delivered by the user interactive unit 10. The control panel 21 comprises a plurality of control buttons 211 each of which is associated with a predetermined response of the user with respective to the interactive signal for dialing the target phone number or commanding the user interactive unit 10 to deliver the interactive signal of the next entry identification 711 stored in the phone 70. In other words, the user able to press one of the control buttons 211 for activating dialing of the target phone number via the central processing unit 30. However, when the entry identification 711 read by the user interactive unit 10 does not match with the entry identification 711 of the target phone number, the user is able to press another of the control buttons 211 for commanding the user interactive unit 10 is deliver the interactive signal of the next entry identification 711. Moreover, the user is also able to initiate a dialing request through the phone 70 by controlling specific initializing button as one of the control buttons 211 in the control panel 21.

It is worth mentioning that the central processing unit 30 can be electrically connected to the phone 70, such as the cellular phone, by means of a wide variety of methods and technologies. Preferably, the central processing unit 30 is wirelessly communicated with the phone 70 via such wireless information technology as Bluetooth communication or radio frequency (RF) communication. Thus, the central processing unit 30 comprises a central processor 31 processing information transmitting between the user interactive unit 10, the response receiver 20 and the phone 70, a wireless device 32 electrically communicated with the central processor 31 to wirelessly communicate with the phone 70 via conventional wireless communication technology such as Bluetooth or radio frequency transmission, and a memory device 33 electrically connected with the central processor 31 and the wireless device 32 to store recorded voice signal in the form of digital data. Thus, the user is able to record the corresponding pronunciation of the entry identification 711 of each of the phone entries 71 contained in the phone 70. Alternatively, the pronunciation of each of the entry identification 711 (such as “David”) can also be created using specific pronunciation software which is capable to generate a corresponding pronunciation according to the English characters inputted as the entry identification 711. It is worth mentioning that corresponding software can also be pre-loaded into central processing unit 30 to recognize foreign languages so that the present invention can also create pronunciation of foreign languages when the entry identification 711 is inputted through the corresponding foreign languages.

In order to further enhance the features of the present invention, the response receiver 20 can be wirelessly communicated with the central processing unit 30 via the wireless device 32 so that the user can selectively dial the target phone number through controlling the response receiver 20 at a distance from the central processing unit 30. Accordingly, the response receiver 20 further comprises a wireless receiver device 22 electrically and wirelessly communicated with the central processing unit 30 through the wireless device 32, wherein the wireless receiver device 22 is adapted to communicate the response signal to the central processing unit 30 wirelessly through conventional wireless communication technology. Thus, the wireless receiver device 22 also comprises the control buttons 211 formed thereon. According to a preferred embodiment of the present invention, the wireless receiver device 22 is embodied as a compact switch which is detachably attached onto a fixture, such as a driving wheel of the vehicle. Moreover, a receiver housing 221 can be provided for storing the wireless receiver device 22, and is detachably attached onto an external fixture, such that a user is able to operate the control buttons 211 on the wireless receiver device 22.

Moreover, the electronic phone book can be set up and stored in the memory device 33 so that when the activation response signal is received, the central processor 31 is adapted to activate the phone 70 to dial the phone number 712 corresponding to the confirmed entry identification 711 of the electronic phone book as the target phone number. Thus, there is no need for the phone 70 to actually store the relevant entry identification 711 and the phone number 712. The central processor 31 can simply dial the phone number 712 through the phone 70 upon confirmation by the user. Alternatively, the phone book originally created in the phone 70 can be exported to the memory device 33 via the wireless device 32 through conventional wireless information transmission technology, such as Bluetooth transmission technology. However, it is worth mentioning that the central processor 31 can also be synchronized to directly read the phone book of the phone 70 to and activates the phone 70 to dial the target phone number.

Thus, the user interactive unit 10 further comprises a voice recorder 13 electrically connected with the central processing unit 30 and specifically the memory device 33 for recording the pronunciation of the entry identifications 711, wherein the recorded data is stored into the memory device 33 for future retrieval and executed by the central processor 31 and the user interactive unit 10.

It is also important to mention that the memory device 33 can be built-in in some fixture (such as in a dashboard of a vehicle) to electrically connect with the main processor 31, or it can be detachably connect with the main processor 31 so that the user is able to record and save the pronunciation of the entry identification 711 by using a computer or other voice recording devices. As such, typical memory devices 33 can be a USB memory stick and the dialing system further comprises a plurality of data exchange ports 60 (such as a USB ports) electrically connected with the central processing unit 30 for allowing exchange of information (mainly the pronunciation data of the entry identification 711) between the memory device 33 and the main processor 31. Alternatively, the memory device 33 can be a hard drive for storing the corresponding recorded data.

In order to further enhance the feature of the present invention, the dialing system further comprises an entertainment control unit 80 electrically connected with the central processing unit 30 and the user interactive unit 10 wherein the entertainment control unit 80 is adapted for remotely controlling predetermined multimedia devices (such as a MP3 player or even an IPOD multimedia player) so that user is able to control (wired or wirelessly through conventional wireless information communication technology such as Bluetooth technology) the multimedia device through the control buttons 211. Moreover, the audible signal contained in the multimedia can also be delivered through the user interactive unit 10 so that a user is able to enjoy a comprehensive entertainment and phone service while engaging in other activities, such as driving. As such, the user is able to dial a number by “ear and finger” and would not be distracted from selecting the target phone number from what may be a lengthy and tedious phone book. It is also worth mentioning that the dialing system of the present invention can be incorporated into a cellular phone so that when the user is engaging in other activities such as driving while wishing to dial the target phone number, the user is able to activate the headset function of the cellular phone and utilize the speaker and the display screen of the cellular phone as the user interactive unit 10 for dialing the target phone number as prescribed in the above description.

Alternatively, the multimedia player can also be directly connected with the central processing unit 30 in such a manner that the multimedia materials are delivered through the user interactive unit 10.

It is important to mention that the dialing system of the present invention can be built-in into a predetermined fixture, such as a vehicle, so that the user is able to conveniently manage dialing of the target phone number. Alternatively, the dialing system further comprises a control housing 90 mounted onto the fixture, such as the dashboard of a vehicle, wherein the user interactive unit 10, the response receiver 20, the central processing unit 30, and the entertainment control unit 80 is provided within or on the control housing 90 so as to constitute a self-contained dialing unit for wirelessly or electrically connecting to the phone 70. The control housing 90 comprises a plurality of connection sockets 50 for allowing the central processing unit 30 to electrically connect with the phone 70 or the multimedia player through the corresponding connection sockets 50. The control housing 90 can take a wide variety of physical forms. For example, the control housing 90 can be incorporated as the housing of a wrist watch so that the user interactive unit 10, the response receiver 20 and the central processing unit 30 are all incorporated into the wrist watch. As such, the user can remotely dial a phone number by operating the wrist watch as the control housing 90 of the present invention. Alternatively, the control housing 90 can only contain the central processing unit 30 wherein the interactive unit 10 and the response receiver 20 can be wirelessly or electrically (in a wired manner) connected with the central processing unit 30.

The dialing system further comprises a power device 100 electrically connected with the user interactive unit 10, the response receiver 20, and the central processing unit 30 for providing adequate energy for operating these components. The power device 100 can be embodied as a rechargeable or disposable battery for independently supplying power to the interactive unit 10, the response receiver 20 and the central processing unit 30. Alternatively, the power device 100 can be embodied as a transformer adapted for electrically connecting with an external power source, such as a car battery in the vehicle. Moreover, the power device 100 can comprise both the transformer and the rechargeable and/or a disposable battery for operating the central processing unit 30, the response receiver 20 and the interactive unit 10.

The central processing unit 30 and the phone 70 can also be connected via traditional cable through specific sockets and plugs so that the user is able to conveniently and manually connect the dialing system with the phone 70. In other words, the dialing system comprises the connection socket 50 formed on the control housing 90 to electrically connected with the central processing unit 30, wherein a user is able to electrically connect the phone 70 with the dialing system of the present invention via conventional cable having a predetermined connecting plug by plugging the connecting plug into the connecting socket 50.

It is also worth mentioning the present invention can be used in conjunction with a conventional Bluetooth headset. As such, the wireless device 32 comprises a wireless transceiver 321 electrically connected with the main processor 31, and a Bluetooth module 322 wirelessly connecting with the wireless transceiver 321, wherein the Bluetooth module 322 and the audio device 11 can be incorporated to form a single Bluetooth audio compact unit adapted to attach onto the user's body, such as the user's ear. Moreover, the control buttons 221 may also be formed on the Bluetooth module 322 so that the user may be able to operate the control buttons 221 on the Bluetooth module 322. Alternatively, the dialing system may have a first and a second audio device 11 wherein the first audio device 11 is connected as described above while the second audio device 11 is incorporated into the Bluetooth module 322.

According to the preferred embodiment of the present invention, the dialing system can be implemented in a wide variety of applications with some slight modifications in order to fit different needs. At least four different variations of applications can be appreciated:

### EXAMPLE 1

The Bluetooth module 322 may be electrically connected with the central processing unit 30 in a wired manner through conventional cable. As such, the control housing 90 can have a specifically defined platform for allowing the Bluetooth module 322 to dispose therein for electrically connecting the Bluetooth module 322 directly with the central processor 31. As a result, when the Bluetooth module 322 is disposed in the control housing 90 and electrically connected with the central processor 31, the Bluetooth module 322 can be selectively or temporarily deactivated so that the wireless receiver device 22 wirelessly communicates with the wireless transceiver 321. The relevant audio signal will then be delivered through the audio device 11 not incorporated into the Bluetooth module 322 (i.e. the first audio device 11).

### EXAMPLE 2

The Bluetooth module 322 can also be adapted to selectively provide private phone conversation through wireless connection with the phone 70. For example, when the target phone number has yet to be confirmed by the user of the present invention, he or she may dispose the Bluetooth module 322 in the control housing 90 so that the audible signal can be delivered through the first audio device 11, and when the target phone number has been confirmed and that the phone 70 has been activated to dial the target phone number, the user may then detach the Bluetooth module 322 from the control housing 90 so that he or she may talk to the other party via the Bluetooth module 322 (and the second audio device 12) without activation of the first audio device 11. In other words, the wireless transceiver 321, upon receipt of the activation response signal, is adapted to wirelessly communicated with the Bluetooth module 322 so that upon when dialing of the target phone number has been carried out, the user is able to talk on the phone 70 via the Bluetooth module 322 in a private manner (i.e. the conversation would not be overheard by third party).

### EXAMPLE 3

the response receiver 20 and the Bluetooth module 322 are incorporated into a signal unit so that the control buttons 211 are provided on the Bluetooth module 322. When the user wishes to operate the control buttons 211 so as to initiate the rejection response signal or the activation response signal, the user can simply operate the control buttons 211 on the Bluetooth module 322 for wirelessly communicating with the wireless transceiver 321. On the other hand, the user interactive unit 10 and the central processing unit 30 are incorporated into the phone 70, such as a cellular phone, so that the user may simply hold its cellular phone and the Bluetooth module 322 for dialing the target phone number in the manner described above.

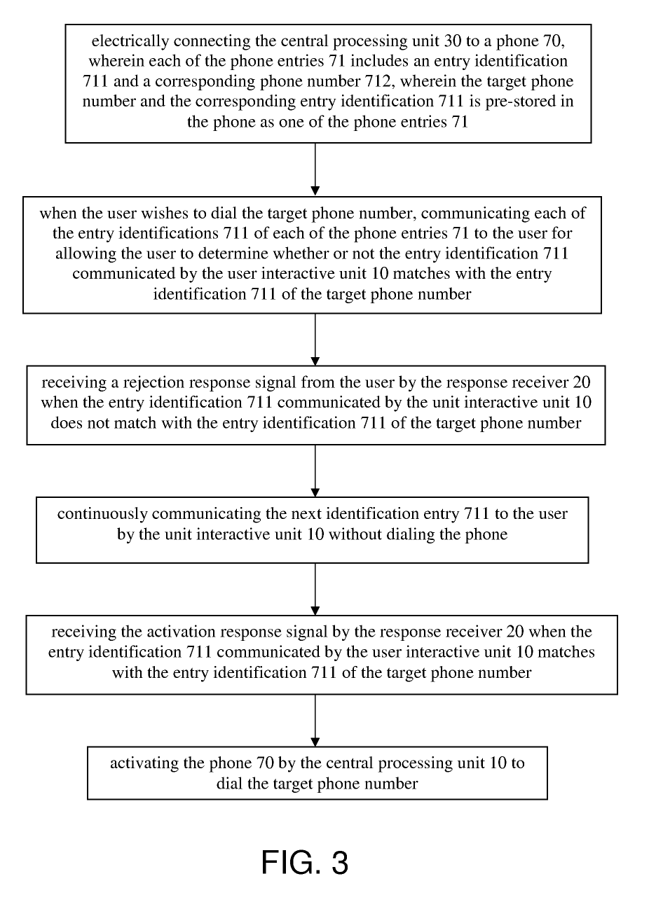

Referring to FIG. 3 of the drawings, a method of dialing a target phone number through a dialing system comprising a user interactive unit 10, a response receiver 20 and a central processing unit 30, wherein the method comprises the steps of:

(a) electrically connecting the central processing unit 30 to a phone 70 containing a phone book which stores a plurality of phone entries 71, wherein each of the phone entries 71 includes an entry identification 711 and a corresponding phone number 712, wherein the target phone number and the corresponding entry identification 711 is pre-stored in the phone as one of the phone entries 71;

(b) when the user wishes to dial the target phone number, communicating each of the entry identifications 711 of each of the phone entries 71 to the user for allowing the user to determine whether or not the entry identification 711 communicated by the user interactive unit 10 matches with the entry identification 711 of the target phone number;

(c) receiving a rejection response signal from the user by the response receiver 20 when the entry identification 711 communicated by the unit interactive unit 10 does not match with the entry identification 711 of the target phone number;

(d) continuously communicating the next identification entry 711 to the user by the unit interactive unit 10 without dialing the phone;

(e) receiving the activation response signal by the response receiver 20 when the entry identification 711 communicated by the user interactive unit 10 matches with the entry identification 711 of the target phone number; and

(f) activating the phone 70 by the central processing unit 10 to dial the target phone number.

According to the preferred embodiment of the present invention, step (b) comprises the step (b.1) of reading a first entry identification 711 of the first phone entry 71 contained in the phone book to the user through the user interactive unit 10 so as to allow the user to determine if the entry identification 711 read by the user interactive unit 10 matches with the entry identification 711 of the target phone number. As mentioned earlier, the entry identification 711 read by the user interactive unit 10 can be pre-recorded by the user for verbally communicating to the user.

Step (c) comprises the steps of:

(c.1) awaiting a rejection response signal from the user when the user interactive unit 10 communicates the entry identification 711 to the user; and

(c.2) sensing the rejection response signal from the user by the response receiver 20 when the entry identification 711 communicated by the user interactive unit 10 does not match with the entry identification 711 of the target phone number.

When the identification entry 711 read by the user interactive unit 10 does not match with the identification entry 711 of the target phone number, step (d) comprises a step of reading a second entry identification 711 of the second phone entry 71 contained in the phone book to the user through the user interactive unit 10 so as to allow the user to determine if the subsequent entry identification 711 read by the user interactive unit 10 matches with the entry identification 711 of the target phone number.

Similarly, step (e) comprises the steps of:

(e.1) awaiting an activation response signal from the user when the user interactive unit 10 communicates the entry identification 711 to the user; and

(e.2) sensing the activation response signal from the user by the response receiver 20 when the entry identification 711 communicated by the user interactive unit 10 matches with the entry identification 711 of the target phone number.

The method further comprises a step of pre-recording an audible voice of each of the entry identification 711 so that the user interactive unit 10 is capable of sequentially reading the recoded voice of the entry identification 711 to the user until the entry identification 711 of the target phone number is found.

Step (f) comprises the steps of:

(f.1) wirelessly communicating by the central processing unit 30 to the phone 70; and

(f.2) activating dialing of the target phone number which corresponds to the entry identification 711 confirmed by the user.

It is also worth mentioning that in step (f.1), the communication between the central processing unit 30 and the phone 70 can also be established through traditional wiring method. As such, the phone 70 is electrically connected to the central processing unit 30 through cables and wires.

An exemplary operation of the present invention is as follows: suppose that the phone 70 is a cellular phone which contains a phone book having five phone entries 71, which are listed below:

| Phone Entry 71 | Entry Identification 711 | Phone Number 712 |
|---|---|---|
| First | Sam | 123-456-7890 |
| Second | Jacqueline | 123-456-7891 |
| Third | Katherine | 123-456-7892 |
| Fourth* | David | 123-456-7893 |
| Fifth | Peter | 123-456-7894 |

Suppose that the target phone number is 123-456-7893, and the corresponding entry identification is the fourth entry identification 711 stored in the phone book (i.e. David). That means the user desires to call David while engaging in some other activities, such as driving. When I activate the dialing system of the present invention, the user interactive unit 10 is arranged to read “Sam” through the speaker unit 11. When the user has heard of the name “Sam”, he or she may press the corresponding control buttons 211 on the control panel 21 so as to transmit a rejection response signal to the central processing unit 30. The interactive unit 10 is then arranged to read the next entry identification 711 stored in the phone book (i.e. Jacqueline) for user's confirmation. Since Jacqueline is not the person the user is willing to call, the user will continue entering corresponding rejection response signals until the name “David” is called by the user interactive unit 10. When this happens, the user will then press the corresponding control buttons 211 on the control panel 21 so as to transmit an activation response signal to the central processing unit 30. The central processing unit 30 will then wirelessly activate the cellular phone for activating dialing of the corresponding phone number 712, which is the target phone number of that user.

One skilled in the art will understand that the embodiment of the present invention as shown in the drawings and described above is exemplary only and should not be limited as such. From the forgoing descriptions, it can be shown that the objects of the present invention have been fully and effectively accomplished. The embodiments have been shown and described for the purposes of illustrating the functional and structural principles of the present invention and is subject to change without departure from such principles. This invention includes all modifications encompassed within the spirit and scope of the following claims.

What is claimed is:

1. A dialing system for activating a phone to dial a target phone number from an electronic phone book having a plurality of phone entries, wherein each of said phone entries includes an entry identification and a corresponding phone number, wherein said remote dialing system comprises:
a user interactive unit adapted for delivering an interactive signal to a user;
a response receiver for receiving a response signal from said user; and
a central processing unit electrically connecting with said response receiver and said user interactive unit and electrically connected with said phone to retrieve said phone entries, wherein said central processing unit is pre-programmed to activate said phone to dial said target phone number in such a manner that when said user wishes to dial said target phone number, said central processing unit is arranged to first activate said user interactive unit to communicate each of said entry identifications of each of said phone entries for allowing said user to determine whether or not said entry identification communicated by said user interactive unit matches with said entry identification of said target phone number, wherein when said entry identification communicated by said unit interactive unit does not match with said entry identification of said target phone number, said response receiver is arranged to receive a corresponding rejection response signal from said user to activate said user interactive unit to communicate said next identification entry without dialing said corresponding phone number, and when said entry identification communicated by said user interactive unit matches with said entry identification of said target phone number, said response receiver is arranged to receive said corresponding activation response signal from said user for confirming dialing of said target phone number, so that when said activation response signal is received and transmitted to said central processing unit, said central processing unit is arranged to activate said phone to dial said target phone number.

2. The dialing system, as recited in claim 1, wherein said response receiver comprises a control panel electrically connected with said central processing unit and said user interactive unit, and is arranged to receive a said response signal in responsive to said interactive signal delivered by said user interactive unit, wherein said control panel comprises a plurality of control buttons each of which is associated with a predetermined response signal of the user with respective to said interactive signal for dialing said target phone number or commanding said user interactive unit to deliver said interactive signal of said next entry identification of said next phone entry.

3. The dialing system, as recited in claim 1, wherein said central processing unit is wirelessly communicated with said phone, and comprises a central processor processing information transmitting between said user interactive unit, said response receiver and said phone, a wireless device electrically communicated with said central processor to wirelessly communicate with said phone, and a memory device electrically connected with said central processor and said wireless device to store voice signal in the form of digital data, wherein said voice signal is said audible voice of each of said entry identifications.

4. The dialing system, as recited in claim 2, wherein said central processing unit is wirelessly communicated with said phone, and comprises a central processor processing information transmitting between said user interactive unit, said response receiver and said phone, a wireless device electrically communicated with said central processor to wirelessly communicate with said phone, and a memory device electrically connected with said central processor and said wireless device to store voice signal in the form of digital data, wherein said voice signal is said audible voice of each of said entry identifications.

5. The dialing system, as recited in claim 3, wherein said user interactive unit comprises an audio device arranged to deliver an audible signal as said interactive signal to said user for verbally communicating said entry identification to said user.

6. The dialing system, as recited in claim 4, wherein said user interactive unit comprises an audio device arranged to deliver an audible signal as said interactive signal to said user for verbally communicating said entry identification to said user.

7. The dialing system, as recited in claim 5, said user interactive unit further comprises a voice recorder electrically connected with the central processing unit for recording pronunciation of said entry identifications which are to be read by said user interactive unit.

8. The dialing system, as recited in claim 6, said user interactive unit further comprises a voice recorder electrically connected with the central processing unit for recording pronunciation of said entry identifications which are to be read by said user interactive unit.

9. The dialing system, as recited in claim 7, further comprising an entertainment control unit electrically connected with said central processing unit and said user interactive unit, wherein said entertainment control unit is adapted for remotely controlling a predetermined multimedia device so that said user is able to control said multimedia device through said control panel.

10. The dialing system, as recited in claim 8, further comprising an entertainment control unit electrically connected with said central processing unit and said user interactive unit, wherein said entertainment control unit is adapted for remotely controlling a predetermined multimedia device so that said user is able to control said multimedia device through said control panel.

11. The dialing system, as recited in claim 1, further comprising a control housing mounted onto an external fixture, wherein said user interactive unit, said response receiver, and said central processing unit are provided on said control housing so as to constitute a self-contained dialing unit for wirelessly and electrically connecting said phone for dialing said target phone number.

12. The dialing system, as recited in claim 6, further comprising a control housing mounted onto an external fixture, wherein said user interactive unit, said response receiver, and said central processing unit are provided on said control housing so as to constitute a self-contained dialing unit for wirelessly and electrically connecting said phone for dialing said target phone number.

13. The dialing system, as recited in claim 10, further comprising a control housing mounted onto an external fixture, wherein said user interactive unit, said response receiver, and said central processing unit are provided on said control housing so as to constitute a self-contained dialing unit for wirelessly and electrically connecting said phone for dialing said target phone number.

14. The dialing system, as recited in claim 7, wherein said response receiver further comprises a wireless receiver device, adapted for detachably connected to an external fixture, wirelessly and electrically connected with said central process unit, wherein said wireless receiver device comprises a plurality of said control buttons for initializing said corresponding response signal for selectively controlling dialing of said target phone number.

15. The dialing system, as recited in claim 8, wherein said response receiver further comprises a wireless receiver device, adapted for detachably connected to an external fixture, wirelessly and electrically connected with said central process unit, wherein said wireless receiver device comprises a plurality of said control buttons for initializing said corresponding response signal for selectively controlling dialing of said target phone number.

16. The dialing system, as recited in claim 4, wherein said wireless device comprises a wireless transceiver electrically connected with the main processor, and a Bluetooth module wirelessly connecting with said wireless transceiver and said phone, wherein said Bluetooth module and said audio device are incorporated to form a single unit for delivering said audible signal and for wirelessly activating said phone to dial said target phone number.

17. The dialing system, as recited in claim 6, wherein said wireless device comprises a wireless transceiver electrically connected with the main processor, and a Bluetooth module wirelessly connecting with said wireless transceiver and said phone, wherein said Bluetooth module and said audio device are incorporated to form a single unit for delivering said audible signal and for wirelessly activating said phone to dial said target phone number.

18. The dialing system, as recited in claim 8, wherein said wireless device comprises a wireless transceiver electrically connected with the main processor, and a Bluetooth module wirelessly connecting with said wireless transceiver and said phone, wherein said Bluetooth module and said audio device are incorporated to form a single unit for delivering said audible signal and for wirelessly activating said phone to dial said target phone number.

19. A method of dialing a target phone number through a dialing system comprising a user interactive unit, a response receiver and a central processing unit, wherein said method comprises the steps of:
(a) reading an electronic phone book by said central processing unit, wherein said electronic phone book stores a plurality of phone entries, wherein each of said phone entries includes an entry identification and a corresponding phone number, wherein said target phone number and said corresponding entry identification is pre-stored in said phone book as one of said phone entries;
(b) when said user wishes to dial said target phone number, communicating each of said entry identifications of each of said phone entries to said user for allowing said user to determine whether or not said entry identification communicated by said user interactive unit matches with said entry identification of said target phone number;
(c) receiving a rejection response signal from said user by said response receiver when said entry identification communicated by said unit interactive unit does not match with said entry identification of said target phone number;
(d) continuously communicating said next identification entry to said user by said unit interactive unit without dialing said phone;
(e) receiving an activation response signal by said response receiver when said entry identification communicated by said user interactive unit matches with said entry identification of said target phone number; and
(f) activating said phone by said central processing unit to dial said target phone number.

20. The method, as recited in claim 19, wherein said step (b) comprises the step (b.1) of reading said first entry identification of said first phone entry contained in said phone book to said user through said user interactive unit so as to allow said user to determine if said entry identification read by said user interactive unit matches with said entry identification of said target phone number.

21. The method, as recited in claim 19, wherein said step (c) comprises the steps of:
(c.1) awaiting a rejection response signal from said user when said user interactive unit communicates said entry identification to said user; and
(c.2) sensing said rejection response signal from said user by said response receiver when said entry identification communicated by said user interactive unit does not match with said entry identification of said target phone number.

22. The method, as recited in claim 21, wherein step (d) comprises a step of reading a second entry identification of said second phone entry contained in said phone book to said user through said user interactive unit when said identification entry read by said user interactive unit does not match with said identification entry of said target phone number, so as to allow said user to determine if said subsequent entry identification read by said user interactive unit matches with said entry identification of said target phone number.

23. The method, as recited in claim 22, wherein said step (e) comprises the steps of:
(e.1) awaiting an activation response signal from said user when said user interactive unit communicates said entry identification to said user; and
(e.2) sensing said activation response signal from said user by said response receiver when said entry identification communicated by said user interactive unit matches with said entry identification of said target phone number.

24. The method, as recited in claim 23, wherein further comprising a step of pre-recording an audible voice of each of said entry identification so that said user interactive unit is capable of sequentially reading said recoded voice of said entry identification to said user until said entry identification of said target phone number is found, wherein said recoded audible voice is stored in a memory device.

25. The method, as recited in claim 24, wherein said step (f) comprises the steps of:
(f.1) wirelessly communicating by said central processing unit to said phone; and
(f.2) activating dialing of said target phone number which corresponds to said entry identification confirmed by said user.
